(19) United States
(12) Patent Application Publication
(10) Pub. No.: US 2009/0136076 A1
(43) Pub. Date: May 28, 2009

(54) Portable inflatable and illuminative speaker

(75) Inventor: Hwa-Jei Chi, Chung-Ho (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(73) Assignee: Hwa Yang Technology Co., Ltd.

(21) Appl. No.: 11/984,913

(22) Filed: Nov. 26, 2007

(51) Int. Cl. H04R 1/02

(52) U.S. Cl. 381/387

(57) ABSTRACT

The present invention is to provide a speaker, whose surface is distributed with glittering cones, made the user's sense of being positioned within a real, three dimensional space, further the speaker is free from damage, when fallen down or impinged by surrounding objects. The portable, inflatable, and illuminative speaker can provide visual perception and tactile perception. A portable, inflatable, and illuminative speaker comprising: an audio base (3) pervious to light, a speaker (5) mounted inside the base (3), an electric circuit (6) electrically connected to the speaker (5), at least, one light emission diode (LED) (4) disposed inside the base (3) is electrically connected to the circuit (6), and an inflatable body (1) pervious to light is coupled to an exterior wall of the base (3) and partly covering the same, the inflatable body (1) is further coupled to a neck (7) equipped with a leak-proof plate therein (71).

### FIELD OF THE INVENTION

The invention is to provide a portable inflatable and illuminative speaker.

### BACKGROUND OF THE INVENTION

In TWM302764 entitled “A portable multi-functional apparatus combine MP3/MP4 with speakers” (MP3/MP4 stands for moving picture experts group audio files) to Kuo Ching-Yang on Jul. 12, 2006. Kuo indicated the portable multifunctional apparatus dealing with MP3/MP4 file formats comprising a body, a first speaker, and a second speaker. The first, second speakers are pivotally connected to the body to a first, second sides respectively. First, second speakers are swiveled about pivotal points on both sides. By swiveling, the portable multifunctional apparatus with adjacent speakers alternated in an upright stance, or a reclined posture enhances the apparatus' performance.

The portable multifunctional apparatus has some drawbacks as following:

1. Speaker housing made of hard plastic with lower flexibility; either put it away for safekeeping, or make use of it, causes inconvenience to users. In addition, to meet requirements of enhanced strength on fashion styling, a thick housing of the speaker is developed, and quite a weight on the speaker.

2. To achieve a stable posture, responsive extendible dual-arm like speakers may be added clung to the apparatus, total weight are further increased. Thus a carriage burden of a portable apparatus is gradually amount to some small scale stereo audio system. Furthermore, the apparatus and speakers are aggregated as a carriage burden, but easily broken when impinged or dropped, though audio function system is upgraded, but fashion styling of the apparatus is restricted to a limited scope.

### SUMMARY OF THE INVENTION

The present invention is to provide a speaker, whose surface is distributed with glittering cones, makes the user's sense of being positioned within a real, three dimensional space. Further the speaker is free from damage, when fallen down or impinged by surrounding objects. The portable, inflatable, and illuminative speaker can provide visual perception and tactile perception.

A portable, inflatable, and illuminative speaker comprising: an audio base (3) pervious to light, a speaker (5) mounted inside the base (3), an electric circuit (6) electrically connected to the speaker (5), at least, one light emission diode (LED) (4) disposed inside the base (3) is electrically connected to the circuit (6), and an inflatable body (1) pervious to light is coupled to an exterior wall of the base (3) and partly covering the same, the inflatable body (1) is further coupled to a neck (7) equipped with a leak-proof plate therein (71).

Said portable, inflatable, and illuminative speaker wherein a wall of the inflatable body (1) is composed of a layer (11) pervious to light, and a film (2); the layer (11) pervious to light is formed as an exterior layer of the wall, while the film (2) is formed as an interior layer of the wall; a glossy surface (22) formed at a first side of the film (2) is coupled to the layer (11) pervious to light, a refractive surface (21) formed at a second side of the film (2) is distributed with concave and convex tiny cones processed by pressing.

Said portable, inflatable, and illuminative speaker wherein the glossy surface (21) spread with a film-like printed layer (23) printed with characters, logos, or patterns.

Said portable, inflatable, and illuminative speaker wherein the layer (11) pervious to light is made of polyethylene (PE).

Said portable, inflatable, and illuminative speaker wherein the layer (11) pervious to light has a thickness in the range of 0.15˜0.5 mm.

Said portable, inflatable, and illuminative speaker wherein a hanger (12) is incorporated to a peripheral of the inflatable body (1).

Said portable, inflatable, and illuminative speaker wherein the base (3) is composed of a first cover (31) pervious to light, a second cover (32) coupled to the first cover (31), a stopper (33) coupled to the first cover (31), a plastic battery chamber (34) is disposed on the first cover (31) and covered by the second cover (32), and a lid (35) for sealing an opening of the battery chamber (34).

Said portable, inflatable, and illuminative speaker wherein the control circuit (6) includes a printed circuit board (PCB) (61), at least, one switch (63) electrically connected to the PCB (61) is projected out of the base (3), and at least, one interface (64) is electrically connected to the PCB (61); said PCB (61) is electrically connected to LEDs (4), speaker (5), and batteries inside the battery chamber (34).

Said portable, inflatable, and illuminative speaker wherein the switch (63) is selected from one or combination of the following: speaker power source switch, light fade in/out switch, LEDs power source switch.

Said portable, inflatable, and illuminative speaker wherein the interface (64) is one or combination of the following: mini universal serial bus (USB) port, USB port, and audio input port.

Said portable, inflatable, and illuminative speaker wherein the system chip (62) includes a microprocessor (67) for controlling the LEDs (4) emit light synchronously responsive to music signals, an amplifier (65), and an audio signal decoder (66) decodes coded stream and output audio signal.

### BRIEF DESCRIPTION OF THE DRAWINGS

FIG. 1: shows a perspective view of the portable inflatable and illuminative speaker;

FIG. 2: shows an exploded view of the portable inflatable and illuminative speaker;

FIG. 3: shows a cross sectional view of the portable inflatable and illuminative speaker;

FIG. 4: shows an enlarged sectional view of FIG. 3 indicated by a circle;

FIG. 5: shows a diagrammatic view of access electrical connections of components in the speaker; and

FIG. 6: shows a schematic view of the portable inflatable speaker in use.

### DETAILED DESCRIPTION OF PREFERRED EMBODIMENTS OF THE PRESENT INVENTION

The present invention is described in detail according to the appended drawings hereinafter.

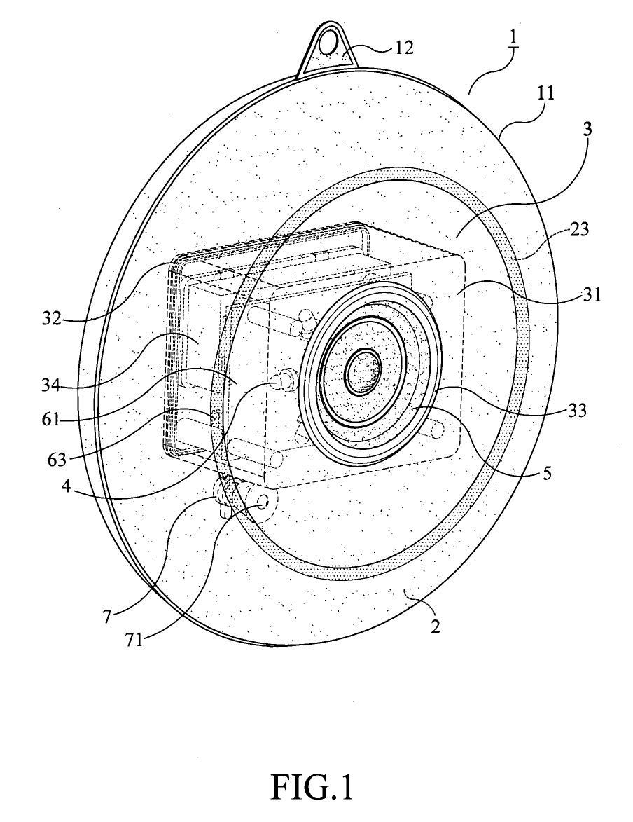

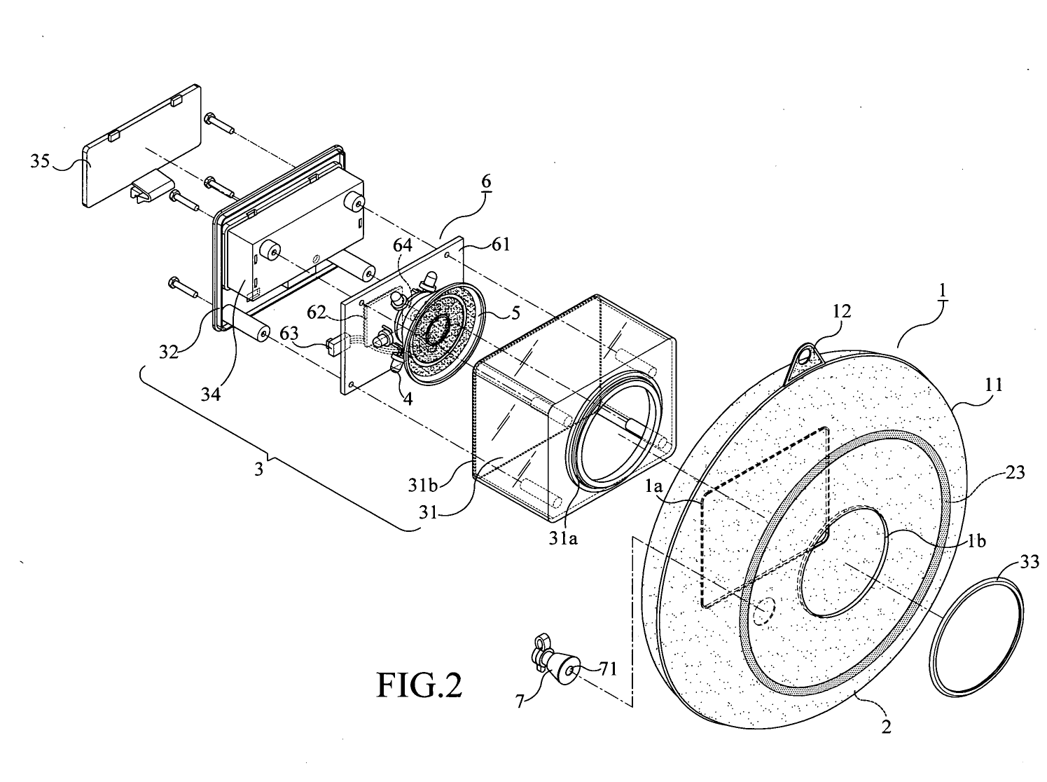

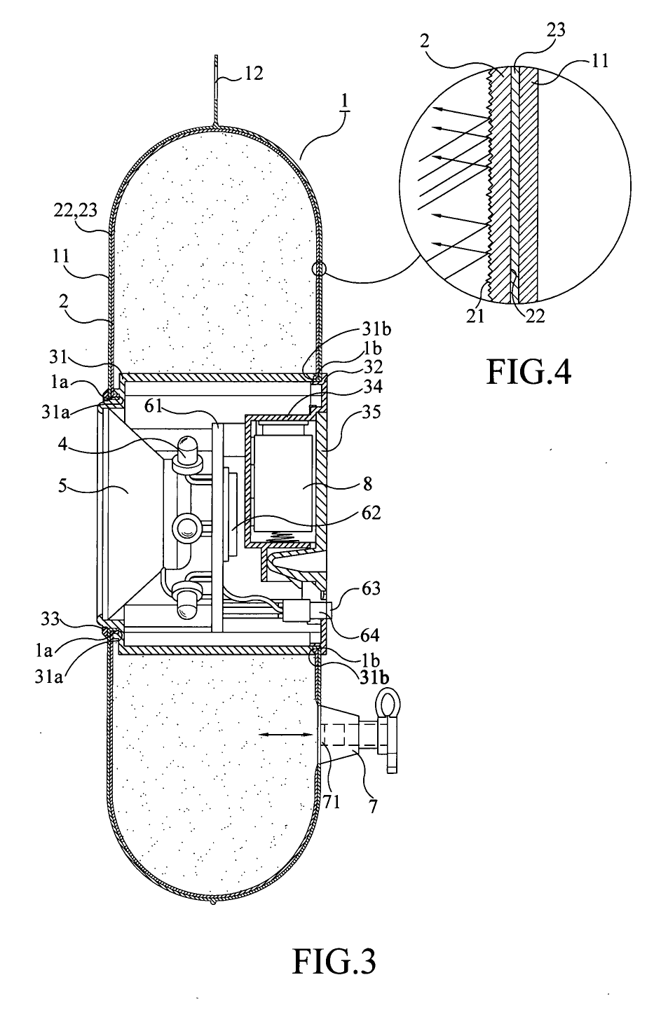

As shown in FIGS. 1˜4, a portable inflatable and illuminative speaker comprising a base (3) pervious to light, at least, one speaker (5) mounted into the base (3), an electric circuit (6) disposed inside the base (3) is electrically connected to the speaker (5), at least, one light emission diode (LED) (4) is electrically connected to the electric circuit (6), an inflatable body (1) pervious to light is coupled to said base (3) for covering an exterior wall of the base in part; a wall of the inflatable body (1) is composed of the layer (11) pervious to light and a film (2), where the layer (11) pervious to light is formed as an exterior layer of the wall, while the film (2) is formed as an interior layer of the wall; a first side of said film (2) coupled to the layer (11) pervious to light forms a glossy surface (22), a second side of said film (2) is a refractive surface (21) processed through pressing, whereby a lot of concave and convex cones fulfill the refractive surface (21). In addition, the portable and inflatable body (1) is further coupled with a leak-proof plate (71) at a neck (7) for blowing in air or helium. When the inflatable speaker is filled up with air or helium, the raised inflatable speaker decorated with light points can show a three dimensional perceptual illusion.

Since the layer (11) pervious to light is the exterior layer, the film (2) is the interior layer. The refractive surface (21) on the second side of the film (2) facing inward is formed with a lot of concave and convex cones, which can refract light injection into the refractive film (2). Before that, the light injection is passed through the printed layer (23), the glossy surface (22) on the first side of the film (2), and the layer (11) pervious to light. A lot of the fabricated cones are lit, likely twinkling star like light points, on an outline of the inflatable body (1).

Likewise, the inflatable body (1) is flexible, and plastic. When the inflatable body (1) is filled up with air, a sufficient elasticity is given. When the body (1) is accidentally collided with others, or dropped off to a floor, the speaker (5) hidden inside the body (1) will not be damaged.

In addition, the neck (7) of the inflatable body (1) is designed for blowing in air only, unless the leak-proof plate (71) is squeezed together to leave a clinched air channel for escaping air, otherwise the blown in air will not be flown out. However, when dead air of the inflatable body is all squeezed out, the inflatable body (1) can be folded up into a smaller size. It is convenient for the inflatable body (1) to be collected. The neck (7) even can be pressed and retracted into the inflatable body (1) to retain an aesthetic feeling with a fashionable outline.

Moreover, the film (2) is coupled to the layer (11) pervious to light by the glossy surface (22). The layer (11) pervious to light is shaped with smooth silky surfaces to both sides, one of them adapted to the glossy surface (22) of the film (2), the glossy surface (22) can be seamlessly laminated to the layer (11) pervious to light. As shown in FIG. 4, opposite to the glossy surface (22), the refractive surface (21) shaped on the second side has concave and convex cones fulfill the refractive surface (21). The concave and convex cones refract light injection into the film (2). Since the concave and convex cones are substantially formed with levels fluctuated up and down along the surface at a depth, when the inflatable body (1) is folded up; the convex and concave cones will absorb/divert/diminish some impact force; thus the refractive surface (21) will not be detached from the film (2) easily.

Besides, a printed layer (23) spread on the glossy surface (22) of the film (2) printed with characters, logos, or patterns by screening, which is given with a better printability so that the layer (11) pervious to light will not be affected by the printed patterns. Thus a fashionable outline of the inflatable body (1) can conform to colorful logos, patterns, and characters with sufficient visual entertainment.

Further, a hanger (12) incorporated to an exterior peripheral of the inflatable body (1) accommodates a string or strap threaded through the hanger (12) to hang on clothing of consumer easy to bring out everywhere in person.

The layer (11) pervious to light is preferably made of polyethylene (PE) layer, a thickness of the layer is in the range of 0.15˜0.5 mm, which is endowed with high transparent potency, a good insulation capacity, and better printability. The thickness of PE layer in the range of 0.15˜0.5 mm is to retain a sufficient elasticity, thus the finished layer is durable and pliable. No damage will be inflicted onto the foldable layer.

LEDs (4), in use, selected from a full color LED with variable light emission, or mono color LED emit light at a certain frequency, either full color or mono color depends on occasions, or what kind of fashion is of prevalence with users.

The base (3) consists of a first cover (31) pervious to light, a second cover (32) coupled to the first cover (31), a stopper (33) coupled to the first cover (31), a plastic battery chamber (34) disposed on the second cover (32) and covered by the first cover (31). A lid (35) is designed for closing an opening formed on the battery chamber (34). The lid (35) is therefore used to protect the LEDs (4) and electric circuit (6), further the speaker (5) disposed on the battery chamber (34) is supported by the lid (35). A power source is supplied from batteries inside the battery chamber (34). The inflatable speaker can be brought out in person; no alternate current (AC) outlet is required.

The inflatable body (1) is secured to the base (3) by fixtures, such as claws (1a) projected out from a brim (claws are opposite to each other on both top and bottom ends) of an opening formed on a second side of the inflatable body (1) fit in grooves (31a) formed on a second side of the first cover (31) close to a wide flare of the speaker (5); and claws (1b) projected out from a brim (claws are opposite to each other on both top and bottom ends) of an opening formed on a first side of the inflatable body (1) fit in grooves (31b) formed on a first side of the first cover (31). Furthermore, the inflatable body (1) can be further secured to the base (3) by the stopper (33) and the second cover (32) without any movements, even when the inflatable body (1) is suffered impacts exerted by an exterior force.

The electric circuit (6) is substantially a controller consists of a PCB (61) inside the base (3), at least, one switch (63) on the PCB (61) is projected out of the base (3), and, at least, one interface (64) electrically connected to the PCB (61). Said PCB (61) is electrically connected to the batteries (8) inside the battery chamber (34), the LEDs (4), and the speaker (5). To integrate multi-media functions of texts, voices, images, pictures . . . etc., the inflatable speaker can be operated in connection with a variety of switches (63), interfaces (64), and devices to provide more entertainment effects.

The switch (63) is selected from one or combination of the following: speaker power source switch, light fade in/out switch, LEDs power source switch. The combination switch is needed for a selectively alternated access to highlight the inflatable speaker's performance in the right occasion.

The interface (64) is one or combination of the following: mini universal serial bus (USB) port, USB port, and audio input port so as to tune in to great music from internet web or other broadcast devices to meet the requirements of users.

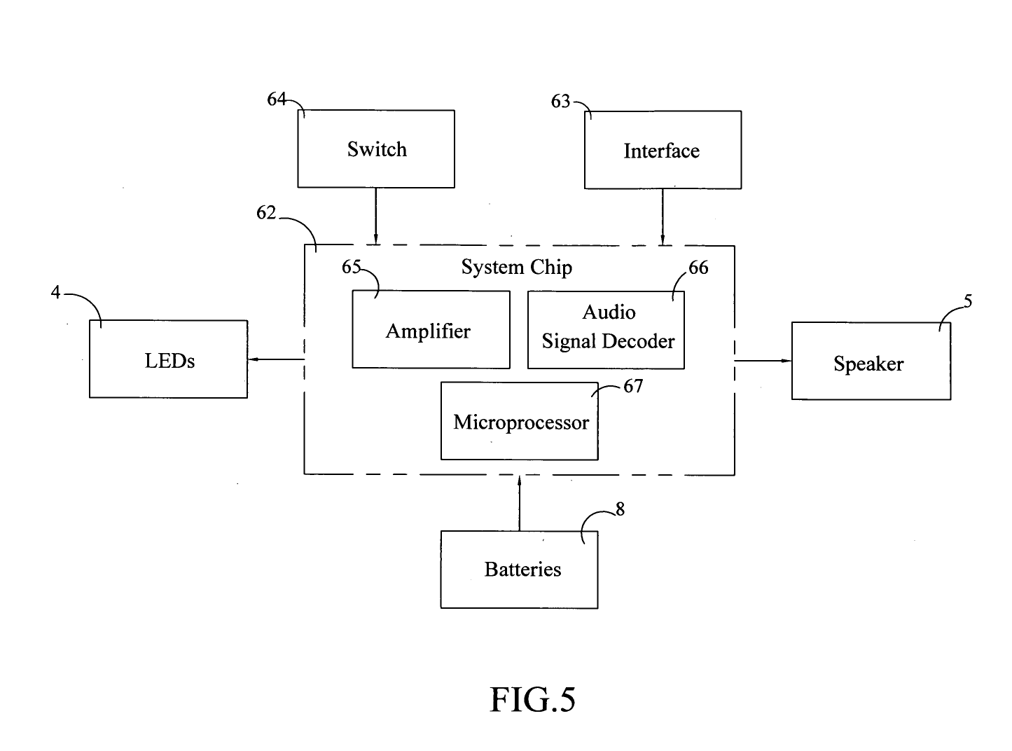

As shown in FIG. 5, a diagrammatic view of access electrical connections of components in the speaker is illustrated. A system chip (62) includes a microprocessor (67) for controlling the LEDs (4) emit light synchronously responsive to music signals, an amplifier (65), and an audio signal decoder (66) decodes coded stream and output audio signal. The system chip (62) further is connected to other broadcast devices by the interface (64), by which the system chip (62) adapts requirements of different systems. Further, the system chip (62) also is electrically connected to self-contained batteries (8) of the PCB in the inflatable speaker, which can be brought out in person. Alternate current (AC) outlet is not necessary for the present invention. Besides, the switch (63) is electrically connected to the system chip (62), whose multi media function is under control by users. The system chip is included in the PCB.

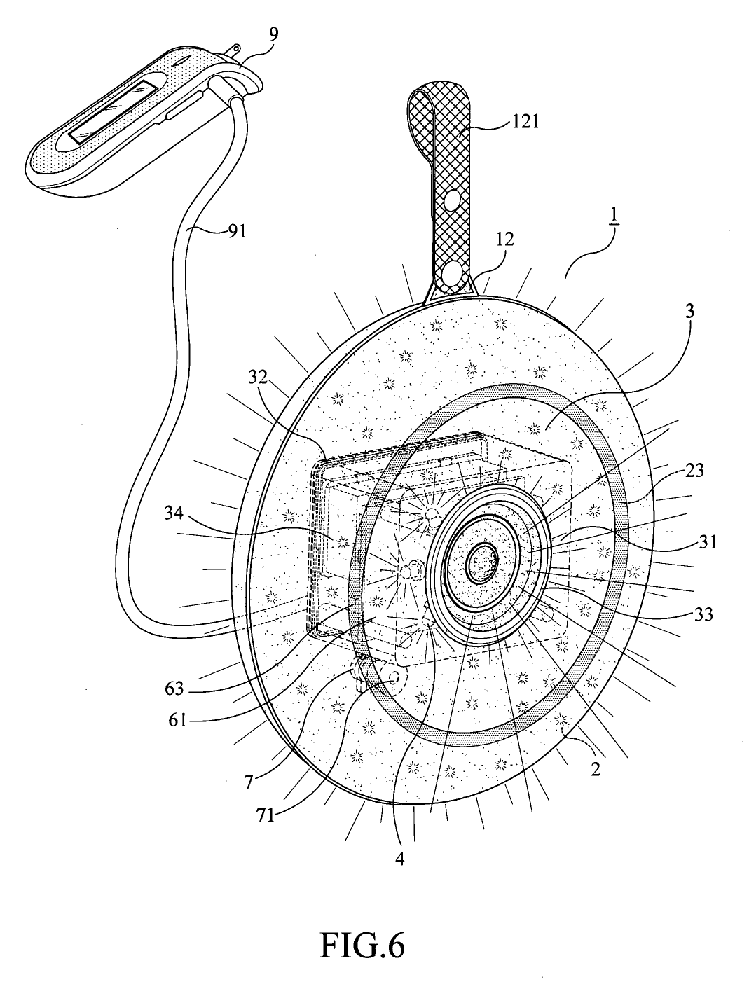

As shown in FIG. 6, a schematic view of the portable inflatable speaker in use is illustrated. A hanger (12) is incorporated to a peripheral of the inflatable body (1), a strap or string (121) threads through the hanger (12). Whereby, the inflatable body (1) can be hung from clothing or backpacks. The inflatable speaker can be activated by the switch (63). LEDs (4) electrically connected to the PCB emit light through the first cover (31). Meanwhile, MP3 player (9) is electrically connected to the interface (64) projected out from the second cover (32) of the base (3) by an audio cable (91). Thereby, the inflatable speaker can broadcast music and emit light responsive to background music change. Further, the inflatable body (1) is coupled to the base (3) by the second cover (32) and the stopper (33) by the refractive surface (21), where a lot of concave and convex cones fulfill the refractive surface (21) refract injection light to form a lot of light points. Thus the inflatable body (1) is illuminated. Let the user's sense of being positioned within a real, three dimensional space in harmony with soft light emitted out from the inflatable speaker. Printed layer (23) on the glossy surface (22) with colorful patterns, logos, and characters (not shown) are highlighted at the same time.

### ADVANTAGE OF EMBODIMENTS OF THE INVENTION

Advantages can be achieved by embodiments of the invention as following:
1. The inflatable body (1) filled up with air can be free from damages, no matter the inflatable body (1) is dropped down or impinged by surrounding objects. Electronic components contained in the inflatable body (1) can be avoided from clinks happened between one another. The inflatable body (1) is mainly provided with visual feedback accompanied by acoustic pulse or music tones and augmented by tactile perception, which is elastic, air-filled, and raised inflatable body (1), if dropped, may be suffered less gravity impact due to the air or helium is already filled within the inflatable body (1).
2. The inflatable body (1) filled up with air shows off an integral pattern to maintain standing posture with a fashionable outline, added with music played by the speaker (5), and light emitted from LEDs (4) for visual-audio entertainment.
3. When the inflatable body (1) filled up with air is fallen out of use, let the air out of the body, the inflatable body (1) made of soft plastic can be folded up and collected in small space.
4. Part of the audio base (3) is wrapped around by the inflatable body (1) with a fashionable outline, but in constant rapport with a standing posture of the inflatable body, the audio base (3) is necessarily designed with a sufficient strength to hold electronic components in place and retained stable operation in the raised inflatable body. Therefore, the inflatable body is easy to carry about than other portable speakers.
5. The layer (11) pervious to light is coupled to the second side of the film (2), which has a refractive surface (21) distributed with concave and convex tiny cones processed by pressing. The refractive surface (21) is therefore shaped with a lot of tiny light points by reflection of light without causing eyesore and dizzy feeling, but a three dimensional effect may be achieved by such tiny cones.
6. The glossy surface (22) of the film (2) is spread with film-like printed layer printed with characters, logos, or patterns. LEDs glittering accords with music signals, more visual entertainment is achieved.

What is claim claimed:

1. A portable, inflatable, and illuminative speaker comprising:
an audio base (3) pervious to light;
a speaker (5) mounted inside the base (3);
an electric circuit (6) electrically connected to the speaker (5);
at least, one light emission diode (LED) (4) disposed inside the base (3) is electrically connected to the circuit (6); and
an inflatable body (1) pervious to light is coupled to an exterior wall of the base (3) and partly covering the same, the inflatable body (1) is further coupled to a neck (7) equipped with a leak-proof plate therein (71).

2. The portable, inflatable, and illuminative speaker of claim 1 wherein a wall of the inflatable body (1) is composed of a layer (11) pervious to light, and a film (2); the layer (11) pervious to light is formed as an exterior layer of the wall, while the film (2) is formed as an interior layer of the wall; a glossy surface (22) formed at a first side of the film (2) is coupled to the layer (11) pervious to light, a refractive surface (21) formed at a second side of the film (2) is distributed with concave and convex tiny cones processed by pressing.

3. The portable, inflatable, and illuminative speaker of claim 2 wherein the glossy surface (21) spread with a film-like printed layer (23) printed with characters, logos, or patterns.

4. The portable, inflatable, and illuminative speaker of claim 2 wherein the layer (11) pervious to light is made of polyethylene (PE).

5. The portable, inflatable, and illuminative speaker of claim 4 wherein the layer (11) pervious to light has a thickness in the range of 0.15˜0.5 mm.

6. The portable, inflatable, and illuminative speaker of claim 1 wherein a hanger (12) is incorporated to a peripheral of the inflatable body (1).

7. The portable, inflatable, and illuminative speaker of claim 1 wherein the base (3) is composed of a first cover (31) pervious to light, a second cover (32) coupled to the first cover (31), a stopper (33) coupled to the first cover (31), a plastic battery chamber (34) is disposed on the first cover (31) and covered by the second cover (32), and a lid (35) for sealing an opening of the battery chamber (34).

8. The portable, inflatable, and illuminative speaker of claim 1 wherein the control circuit (6) includes a printed circuit board (PCB) (61), at least, one switch (63) electrically connected to the PCB (61) is projected out of the base (3), and at least, one interface (64) is electrically connected to the PCB (61); said PCB (61) is electrically connected to LEDs (4), speaker (5), and batteries inside the battery chamber (34).

9. The portable, inflatable, and illuminative speaker of claim 8 wherein the switch (63) is selected from one or combination of the following: speaker power source switch, light fade in/out switch, LEDs power source switch.

10. The portable, inflatable, and illuminative speaker of claim 8 wherein the interface (64) is one or combination of the following: mini universal serial bus (USB) port, USB port, and audio input port.

11. The portable, inflatable, and illuminative speaker of claim 8 wherein the system chip (62) includes a microprocessor (67) for controlling the LEDs (4) emit light synchronously responsive to music signals, an amplifier (65), and an audio signal decoder (66) decodes coded stream and output audio signal.
